(19) United States
(12) Patent Application Publication
(10) Pub. No.: US 2011/0178963 A1
(43) Pub. Date: Jul. 21, 2011

(54) SYSTEM FOR THE DETECTION OF RARE DATA SITUATIONS IN PROCESSES

(75) Inventors: Jehuda Hartman, Rehovot (IL); Joseph Fisher, Jerusalem (IL); Yuri Kokolov, MaAle Adumim (IL); Efim Entin, Jerusalem (IL)

(73) Assignee: Insyst Ltd., Jerusalem (IL)

(21) Appl. No.: 11/666,488

(22) PCT Filed: Oct. 30, 2005
(86) PCT No.: PCT/IL2005/001132

§ 371 Date: Nov. 6, 2007

Related U.S. Application Data
(60) Provisional application No. 60/622,601, filed on Oct. 28, 2004.

(51) Int. Cl. G06F 15/18; G06N 5/02

(52) U.S. Cl. 706/12; 706/47

(57) ABSTRACT

An apparatus for detecting a rare situation in a process described by a plurality of parameters, the apparatus comprising: a parameter value inputter, for inputting values of at least two interrelated parameters of the plurality of parameters, the interrelated parameters constituting at least one cluster, and a rare situation detector for detecting a rare situation according to an alert policy, the alert policy being based at least on an output value of an alert model, the alert model configured to provide the output value as a function of the input parameter values of parameters constituting the at least one cluster.

### FIELD AND BACKGROUND OF THE INVENTION

The present invention relates to warning systems and, more particularly to a method and an apparatus for detection of rare situations occurring during a process.

Alerting in today's large facilities such as power plants is an important function. Known warning systems are generally a two-stage process: automatic detection of a rare situation by a control system issuing an alarm, and manual diagnosis and reaction to the detected situation by operators/experts.

Detection of rare situations is generally based on methods such as Statistical Process Control (SPC) or common Supervisory Control and Data Acquisition (SCADA) that monitor procedures such as limits, rates of change or rarity of values of representative parameters. Once an alarm is issued indicating the occurrence of a rare situation, a manual process is initiated to handle the rare situation.

One of the primary weaknesses of prior art warning systems is that such warning systems are devoid of a systematic way to automatically distinguish between false and real alarms. Also, there is no efficient and reliable method to significantly reduce the number of false alarms. In addition, many warning systems fail to issue an alarm early enough to provide the operator/expert with a sufficient time to take preventive measures.

Another problem is that often an alarm is triggered based on detecting deviant behavior of a single parameter resulting in many false alarms and late alarms. In the art some multi-variant warning systems are known but are limited by a nonflexible pre-programmed logic that does not allow for tracking of unknown or unexpected problems.

U.S. Pat. No. 5,768,119 to Havekost, entitled “Process control system including alarm priority adjustment”, teaches an SPC system including alert priority adjustment. The system includes an alert and event monitoring and display application which users can easily prioritize. The system monitors and uniformly displays diagnostic information on processes comprising different devices. The invention is particularly useful for prioritizing various alerts but does not relate to the causes of alerts nor to preventative measures that can be taken by early detection.

U.S. Pat. No. 5,949,677 to Ho, entitled “Control system utilizing fault detection”, teaches an improved SPC with fault detection and correction capabilities. A redundant control architecture which includes a primary control system and a monitor control system is provided, with each control system generating a control signal. The difference between the two control signals is monitored by a fault detection system. The fault detection system comprises an integrator and a memory capable of recording signal differences for a predetermined period of time. The use of memory allows signal differences to be added to the integrator and subtracted at a later time. This invention is useful for eliminating noise effects but does not relate to the causes of the alerts or to preventative measures that can be taken upon early detection.

U.S. Pat. No. 6,314,328 to Powell, entitled “Method for an alarm event generator” teaches an alert generation method which allows pinpointing the parameter that causes the alert but does not relate to other contributory factors.

The U.S. patent application published as U.S. 20030225466 of the inventor entitled “Methods and Apparatus for early fault detection and alert generation in a process” describes a method and an apparatus for providing early default detection and alert generation in a multi-parameter process, utilizing a multi-dimensional space.

Prior art warning systems generally trigger alarms relating to a single specific unit or device of a monitored plant. In such plants, operators and experts subsequently deduce systemic rare situation. However, such warning systems fail to automatically generate comprehensive or systemic warnings based on an analysis of a facility as a whole.

Finally, prior art warning systems are often based on automatic data analysis that does not allow the incorporation of human knowledge and experience into the alerting logic to improve the quality of a warning system.

There is a widely recognized need for and it would be highly advantageous to have a method and an apparatus for detection of rare situations in processes, devoid of at least some of the disadvantages of the prior art.

### SUMMARY OF THE INVENTION

According to one aspect of the present invention there is provided an apparatus for detecting a rare situation in a process described by a plurality of parameters, the apparatus comprising: a) a parameter value inputter, for inputting values of at least two interrelated parameters of the plurality of parameters, the interrelated parameters constituting at least one cluster of parameters, and b) a rare situation detector for detecting a rare situation according to an alert policy, the alert policy being based at least on an output value of an alert model, the alert model configured to provide the output value as a function of the input parameter values of parameters constituting the at least one cluster.

The apparatus may further comprising a clusterer, associated with the parameter value inputter, for clustering interrelated parameters of the plurality of parameters into one or more clusters.

Preferably, each of the clusters is pre-assigned into a hierarchical structure of cells, wherein each cell represents an entity (e.g., a unit or subunit) of a facility (e.g., an industrial plant, a factory) performing the process, wherein the rare situation detector is configured to provide information relating to a location of the rare situation in the facility based on the hierarchical structure.

Optionally, the alert policy implemented by the apparatus may be based on a probability distribution function, an out of line limit, or a combination thereof.

According to a second aspect of the present invention there is provided a method for detecting a rare situation in a process described by a plurality of parameters, the method comprising: a) inputting values of at least two interrelated parameters of the plurality of parameters, the interrelated parameters constituting at least one cluster of parameters; and b) detecting a rare situation according to an alert policy, the alert policy being based at least on an output value of an alert model, the alert model configured to provide the output value as a function of the input parameter values of parameters constituting the at least one cluster.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and apparatus of the present invention involves performing selected tasks or steps manually, automatically, or in a combination thereof. Preferably, some or all the steps of an the present invention are implemented by hardware, software or a combination thereof. In embodiments of the present invention steps of the invention are implemented as hardware such as circuits or chips. In embodiments of the present invention steps of the invention are implemented as software, generally as software instructions executed by a computer.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustrating an apparatus for detecting a rare situation in a process described by a plurality of parameters, according to a preferred embodiment of the present invention.

FIG. 2 depicts exemplary graphs of parameter value measurement in a power plant.

FIG. 3 illustrates clustering according to a preferred embodiment of the present invention.

FIG. 4 depicts an exemplary cell alert stream of binary records, according to a preferred embodiment of the present invention.

FIG. 5 illustrates a user defined weighting of parameters/indicators according to a preferred embodiment of the present invention.

FIG. 6 illustrates a moving window of input parameters, according to a preferred embodiment of the present invention.

FIG. 7 illustrates summing data pertaining to a moving window of input parameters, according to a preferred embodiment of the present invention.

FIG. 8 illustrates scoring parameter/indicators according to a preferred embodiment of the present invention.

FIG. 9 illustrates a first GUI screen, according to a preferred embodiment of the present invention.

FIG. 10 illustrates a second GUI screen, according to a preferred embodiment of the present invention.

FIG. 11 illustrates a third GUI screen, according to a preferred embodiment of the present invention.

FIG. 12 illustrates an exemplary two-dimensional PDF alert model for a cluster of two interrelated parameters, according to a preferred embodiment of the present invention.

FIG. 13 illustrates an exemplary three-dimensional PDF alert model for a cluster of three interrelated parameters, according to a preferred embodiment of the present invention.

FIG. 14 is a flow chart illustrating a method for detecting a rare situation in a process described by a plurality of parameters, according to a preferred embodiment of the present invention.

FIG. 15 depicts an embodiment of the present invention.

### DESCRIPTION OF THE PREFERRED EMBODIMENTS

The present embodiments comprise an apparatus and methods for detecting rare situations in a process.

An apparatus according to a preferred embodiment of the present invention may be used to monitor a large facility, such as a power plant, a refinery, or a factory, or a unit or subsystem of the facility. The unit itself may be further subdivided into sub-units, each of the facility sub units being monitored with respect to multiple parameters relating thereto, and all the units may be monitored together at the entire facility level, for providing a comprehensive facility level alarm.

A preferred embodiment of the present invention may overcome the limitations of traditional systems. In particular it may provide multi-variant alerting to reduce false alarms, be more accurate than prior art systems, and provide an alarm at an earlier stage of a developing problem. The sensitivity of multi-variant alerting according to the teachings of the present invention is generally higher than the sensitivity of prior art single variable alerting.

A preferred embodiment of the present invention relates to facilities that have a multiplicity of parameters that are measured during operation of the facility. It is assumed that there are combinations of values of these parameters that represent the behavior of sub units of the system. Hence whenever a sub unit has irregular behavior, the respective parameter combinations deviate from normal values or combination of values.

Irregular behavior of a sub unit may be a precursor to a failure of the sub unit, therefore an appropriate alert may be issued to the system operators, so they become aware of the irregular behavior and if necessary take measures so as to prevent potential failure or damage, for example of the sub unit.

An apparatus according to a preferred embodiment of the present invention presents a systematic method to distinguish between normal and rare values of parameter combinations and may issue alerts when a rare situation is detected.

The principles and operation of an apparatus and methods according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

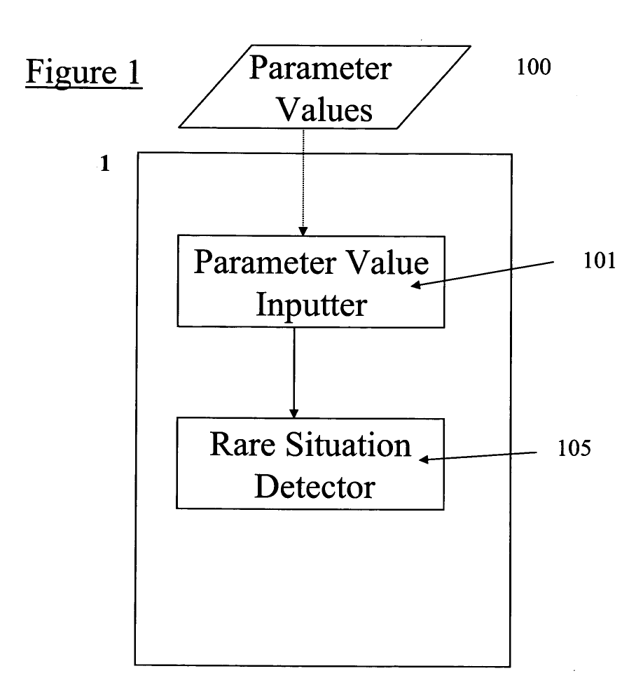

Reference is now made to FIG. 1, which is a block diagram illustrating an apparatus for detecting a rare situation in a process described by a plurality of parameters, according to a preferred embodiment of the present invention.

An apparatus 1 according to a preferred embodiment of the present invention includes a parameter value inputter 101 that is used for inputting values of two or more interrelated parameters of the plurality of parameters 100 into the apparatus 1. The interrelated parameters constitute one or more cluster(s).

The parameter value inputter 101 may include or be associated with, directly or indirectly any known means or sensors for collecting values of parameters that describe the process which is monitored by the apparatus 1.

The apparatus 1 further includes a rare situation detector 105, associated with inputter 101, for detecting a rare situation according to an alert policy which is based on output values of one or more alert model(s). Each of the alert models is configured to provide an output value as a function of input interrelated parameter values of the parameters describing the process.

According to a preferred embodiment, the apparatus 1 further includes a clusterer which communicates with the inputter and is used for clustering interrelated parameters of the plurality of parameters into one or more cluster(s).

The interrelation of parameters to be included in a given cluster may be determined by a field expert, by algorithmic methods, by theoretical considerations or by a combinations thereof.

Preferably, each cluster is pre-assigned into a hierarchical structure of cells, where each cell represents an entity of the facility performing the process. Thus each cell, using the cluster(s) assigned to the cell, may indicate the function of a unit or a sub-unit in the facility performing the process, the cell represents.

Rare situation detector 105 may be configured to provide information relating to a location of the rare situation in the facility based on the hierarchical structure of cells. For example, the information may include the unit where the rare situation occurs, represented by a higher order cell in the hierarchical structure, and the specific sub-unit where the rare situation is detected, represented by a subordinate cell of the higher order cell, in the hierarchical structure, as described in greater detail herein below.

Preferably, a user of the apparatus 1 may be provided with a user interface which allows the user to “drill-through” from a high level cell alert down to a specific subordinate cell of the higher level cell, where a rare situation which triggers the alert occurs, as described in greater detail herein below.

According to a preferred embodiment, the apparatus 1 may further include a discretizator, associated with the imputer 101, for discretizing the input parameter values, as described hereinbelow.

In a preferred embodiment, the apparatus 1 further includes a model generator. The model generator is associated with the inputter 101 and the rare situation detector 105.

The model generator is used to generate one or more alert models that are a part of the alert policy. The model generator may be used to extract knowledge from a field expert such as an engineer or an experienced operator in a facility performing the process. The model generator may also be used to aggregate and process parameter values that are input by the inputter 101.

The model generator may use the knowledge extracted from a field expert and the aggregated and processed input parameter values for generating an alert model, as described in greater detail herein below.

Preferably, the model generator updates the generated alert model dynamically, in accordance with new input parameter values. More preferably, the model generator is configured to ignore failure parameters when generating the alert model, as described in greater detail herein below.

An apparatus according to a preferred embodiment of the present invention includes a user interface manager, associated with the rare situation detector 105, for allowing a user to “drill-through” data, for example values of various parameters, relating to the detected rare situation, as described in greater detail herein below.

As described herein above, apparatus 1 is used for carrying out a multi-variant analysis of parameter values for detecting rare situations in a process.

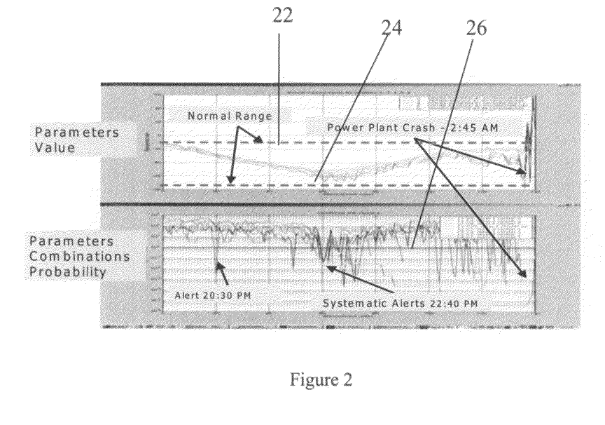

Reference is now made to FIG. 2 which depicts exemplary graphs of parameter value measurement in a power plant.

FIG. 2 may be used to illustrate the advantage of multi-variant detection approach, as implemented in a preferred embodiment of the present invention over prior art approaches where each parameter is individually examined.

The upper graph depicts normalized single parameter value measurements in a power plant. Each individual parameter appears to behave within its regular limits shown as horizontal lines 22 and 24. This continues until 2:45 am where the power plant suddenly crashes without much warning.

The lower graph of FIG. 2 depicts parameter combinations on the same time scale of the same operation according to a preferred embodiment of the present invention. The thicker horizontal line 26 defines a border between regular (above) and irregular (below) parameter combinations. It is apparent from the graph that the first alert appears at 20:30 pm and more alerts appear at 22:40 pm, in effect, several hours before the actual crash takes place.

Prior art warning systems are generally based at an instrument/equipment level or at a low single unit alert level. With such systems, operators and experts who can deduce a high-level alert from a collection of low-level alerts normally perform a type of manual comprehensive alerting.

Prior art systems fail to automatically generate comprehensive alerts based on the analysis of an entire facility, namely not looking only at individual sub-units where any sub-unit may not have produced an alarm, but also at a combination of a number of sub-units each behaving within its normal limits which may in combination deviate from a predetermined normal behavior, thus indicating a rare situation that should trigger generation of an alarm.

According to a preferred embodiment of the present invention, as described herein above, interrelated parameters of the plurality of parameters are clustered into one or more cluster(s). In a preferred embodiment, each cluster is a priori assigned into a hierarchical structure of cells, where each cell represents an entity of the facility performing the process, thus allowing mapping of a rare situation detected according to an alert model pertaining to interrelated parameters included in the cluster into a location within the hierarchical structure of the facility, based on the hierarchical structure of cells.

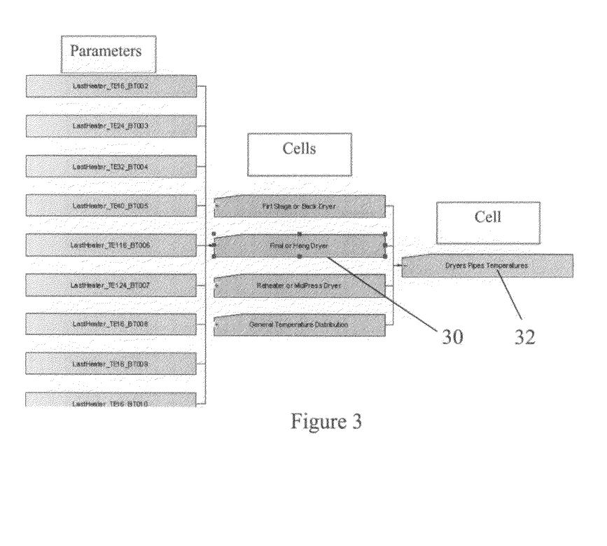

Reference is now made to FIG. 3 which illustrates clustering according to a preferred embodiment of the present invention.

FIG. 3 illustrates sensor data in a hang dryer within a boiler of a power plant. Parameters representing the values of the dryer's sensors are shown on the left of the figure. These parameters are clustered and assigned to a cell (final or hang dryer) 30.

The middle column shown in FIG. 3 consists of four cells each cell having an own cluster of parameters/indicators (the individual parameters/indicators relating to other cells are not shown). These four cells are further combined to a higher level cell/unit on the right, namely to a dryers pipes temperatures cell 32.

Each cell in the hierarchical structure of cells may represent a unit or a sub-unit in the facility performing the process. For example, the cell may represent a boiler, a coal grinder, any other sub-unit or component, or a physical relationship existing in the process, such as mass preservation.

According to a preferred embodiment of the present invention, subordinate cells are aggregated into a higher order cell representing a physical unit and its sub-units, as illustrated in FIG. 3.

Preferably, there is a corresponding set of rules, included in the alert policy. The rules are used to determine how a subordinate cell alert (indicating that a rare situation is detected according to an alert model applied on a cluster which is assigned to the subordinate cell) causes an alert at the level of the higher order alert that the subordinate cell relates to.

An apparatus 1 according to a preferred embodiment of the present invention examines the data stream of input parameter values and detects deviations of the data from a predetermined normal behavior, thus implementing an alert policy based on one or more alert model(s) that may be based on previous data behavior.

A deviation from the predetermined normal behavior may result, depending on the alert policy, in a detection of a rare situation. Upon the detection of the rare situation, an action, such as triggering an alarm, is preferably initiated.

As described hereinabove, according to a preferred embodiment, an alert may be issued when detecting a rare situation, according to one or more alert models. The alert model may be based on a single parameter or on multiple parameters, diverting from pre-defined limits, or on a cluster consisting of collectively examined interrelated parameters which deviate from a predetermined normal behavior as a collective.

As described hereinabove, in a preferred embodiment, each group of input interrelated parameters may be clustered in a cluster. The cluster may be associated with an alert model. The alert model serves to detect a rare situation, based on a comparison between the parameter values and a predetermined normal behavior of the parameters.

In an embodiment of the present invention an alert model is automatically learned from input parameter values. There may be any number and any kind of alert models. The following non-limiting kinds of alert models are examples:
1. PDF—Probability Distribution Function that associates a probability of occurrence with each parameter value or with each parameter value combination. Parameter values with low probability are regarded as rare and trigger alerts. The concept of PDF is discussed in further detail herein below.
2. OOL (Out of Limits)—OOL values are defined by a user to specify the recommended region. A deviation of parameter values from the recommended region may trigger an alert.
3. HC (Hazard Conditions)—HC values are defined by a user to designate catastrophic events and their occurrence may yield an immediate alert.
4. First Principle Formulas—any formula binding some certain parameters, e.g. chemical balance, mass preservation or heat flow, may constitute an alert model.

For example, a cell representing a particular piece of equipment such as a boiler may be assigned with a cluster of interrelated parameters. The cluster may be used as an input to 2 PDF alert models, 3 OOL alert models and one HC alert model.

The cell may be alerted according to a user defined alert policy. For example, the alert policy may include a user-defined rule—that a cell is alerted if at least one of the models indicates a rare situation. The user may define other rules, say that the cell is alerted if at least 2 OOL models and one PDF model is alerted or if the HC model is alerted.

According to a preferred embodiment, the input of each of alert models may be a cluster of any relevant input parameters and/or mathematical transformations of the relevant parameters. For example, the ratio between two input parameters, a formula that is based on several parameters and defines a physically meaningful variable.

Optionally, an alert model according to a preferred embodiment of the present invention may be based on a Boolean function having two values (0/1: 0 for no alert and 1 for alert). Thus, the output of the models at each instant may therefore be a binary record. A cell level alert model for the cell or a sub-unit the cell represents may be developed based on its collected binary records. The alert model uses the cell's binary records to determine whether the cell as a whole issues an alert indicating a rare situation at the cell level.

Optionally, an alert model according to a preferred embodiment of the present invention may further include user defined reasonable limits, set per parameter, for error detection. A deviation from the reasonable limits may be considered an error, or a flier, to be ignored. Optionally, Statistics may be obtained for an out-of-RL situation to indicate failed sensors and equipment or software causing these errors.

According to a preferred embodiment, the cells may be organized hierarchically in a Knowledge Tree representing the logical cause and effect relationships in the facility such as a power plant. The Knowledge Tree structure can be instrumental in diagnosis processes.

According to a preferred embodiment of the present invention, each cell is assigned one or more parameter cluster(s) and associated with an alert model based on one or more alert models, each model input with values of a cluster assigned to the cell.

Optionally, an alert model may include a lookup table. The lookup table may be populated using a PDF. When real-time parameter values are received, the lookup table is referenced to in order to identify whether the occurrence is rare or common. The apparatus 1 may then check observations against the existing information entered into the lookup table, to check if the observation is marked as good or bad.

An alert modeler according to a preferred embodiment of the present invention may dynamically update an alert model at intervals, such that new parameter values are used to update the model so as to reflect the changes in the process.

A learning process produces alert statistics for models and parameters. As a result, if the number of alerts at a certain point is significantly higher than the past number of alerts, a comprehensive sub-unit or unit alert may be issued.

In a preferred embodiment of the present invention, the alert model may be based on a moving window, as described in greater detail in the following text.

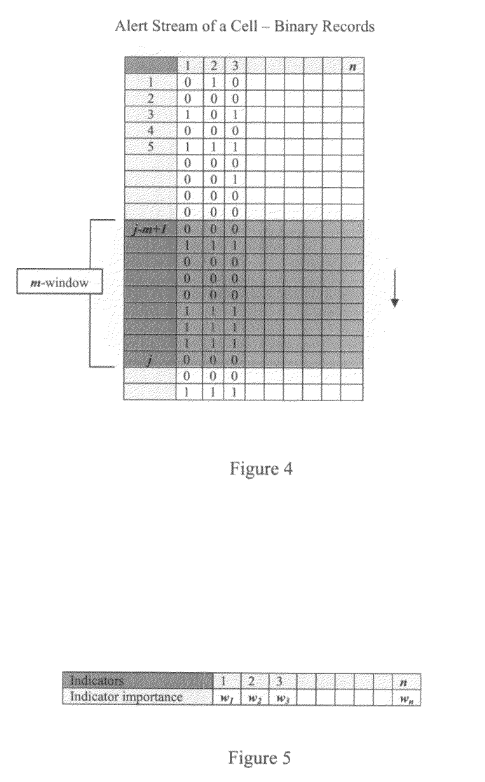

Reference is now made to FIG. 4 which depicts an exemplary cell alert stream of binary records, according to a preferred embodiment of the present invention.

The following definitions are used for the text herein below:
n number of binary digits in the cell's binary records.
N a desirable number of binary records for the learning process.
N₀ minimal number of binary records for learning.
m number of binary records within a moving observation window. The window runs on flowing data. Preferably, at any moment, the window observations reflect the alert status of the cell.
wi User given weight of an parameter/indicator-i (i=1, . . . , n) in terms of

$$\% ( 1 = {\sum }_{i = 0}^{n} {w}_{i} ) .$$

wj denotes the relative importance of parameter/indicator-i to the overall cell alert.

Each input value in the data stream passes through the model's corresponding alert rule, resulting in—xij=1,0 (alert, no alert) of parameter/indicator-i at measurement j. The measurements are typically sensor readings input as parameter values.

Reference is made to FIG. 5 which illustrates a user defined weighting of parameters/indicators according to a preferred embodiment of the present invention.

FIG. 5 illustrates a user definition of weight (wi) expressing the relative importance of parameter/indicator-i is associated with each parameter/indicator, according to an alert model according to a preferred embodiment of the present invention.

According to a preferred embodiment, a moving window (m-window) may be defined, having length m, ending at record (row) j, and starting at record j−m+1.

In the following example, the index j designates the last record of the window. The alert-status of the model is represented by the current-window.

For each m-window ending at record j define:

$$Sij = {\sum }_{k = j - m}^{j} {x}_{ik}$$

$$i = 1 , … , n$$

Sij is the number of alerts in parameter/indicator-i.
The calculation of Sij for parameter/indicator i is done recursively.

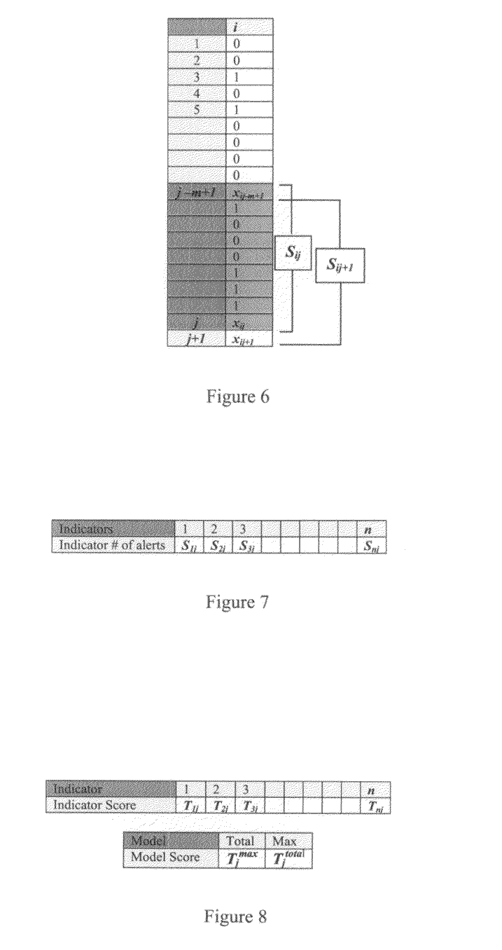

Reference is made to FIG. 6 which illustrates a moving window of input parameters, according to a preferred embodiment of the present invention.

For the moving window presented in FIG. 6, Sij+1=Sij−xij−m+1+xij+1 for i=1, . . . , i. At each step j the values are summarized as shown in FIG. 7.

The average and standard deviation may be calculated over m-windows of N records (the ‘learning set’) Sᵢ^{ave}, Sᵢ^{SD}. The calculations of the learning period are summarized in the values Sᵢ^{ave}, Sᵢ^{ave}

For any given Sij during run-time Sij may be normalized as follows:

Let Tij=(Sij−Sᵢ^{ave})/(Sᵢ^{ave}+1). Tij being the normalized number of alerts of parameter/indicator i in the m-window ending at j.

The window scores that reflect the alert status of the cell may be defined for each m-window (ending at record j). Following are two examples of such scores:

$$1. {T}_{j}^{total} = {\sum }_{i = 1}^{n} {w}_{i} {T}_{ij}$$

is the total value in the m-window (ending at row j).
Tⱼ^{total} is the (weighted) total value in the current window.
   2. Tⱼ^{max}=max (wiTij) where wi denotes an importance of each parameter/indicator, as illustrated in FIG. 5.
Tⱼ^{max} is the (weighted) maximal value of an parameter/indicator in the current window.
   For each m-window, scanning the parameter values/observations dynamically, the two global window scores may be calculated. These values reflect the current severity of cell alerts derived from the current m-window, considering parameter/indicator weights. Both values may be used to trigger cell alerts. High scores indicate a severe alert status of the cell.

In addition to the above described window scores Tⱼ^{max} and Tⱼ^{total}, individual parameter/indicator alerts are also important factors since a parameter/indicator may exhibit unusual behavior indicating local failure, while the window scores do not trigger an alert.

The calculated parameter/indicator scores Tij (per m-window) for all parameter/indicators i=1, . . . , n point at parameter/indicator alert severity and therefore may be used for parameter/indicator alerts. Tij are parameter/indicator scores expressing the relative number of alerts in each parameter/indicator.

Reference is now made to FIG. 8 which illustrates scoring parameter/indicators according to a preferred embodiment of the present invention.

As shown in FIG. 8, each step j, n+2 produces scores for the indicators/parameters.

A policy may be determined to determine whether any of these scores stand out in order to produce appropriate alerts.

For example, it may be assumed that all of these scores are normally distributed, hence the user may determine the threshold values in terms of b which is the number of standard deviations—σ.

For parameter/indicators:

Tij are normalized, hence for an parameter/indicator-i an alert is issued if Tij>=b

For cells:

It may be assumed that the average and standard deviation over m-windows (of the last N records) of Tⱼ^{max}−ave(Tⱼ^{max}) and SD(Tⱼ^{max}) are known;
and that the average and standard deviation over m-windows (of the last N records) of Tⱼ^{total}−ave(Tⱼ^{total}) and SD(Tⱼ^{total}) are known.
We can now normalize these two scores:

Tⱼ^{max}=(Tⱼ^{max}−ave(Tⱼ^{max}))/(SD(Tⱼ^{max})+1)

Tⱼ^{total}=(Tⱼ^{total}−ave(Tⱼ^{total}))/(SD(Tⱼ^{total})+1)

The model may be alerted if the normalized values exceed the threshold of b standard deviations:

TNⱼ^{max}>=b

or

TNⱼ^{total}>=b

Note that the value b reflects α—Type I error probability. In addition, parameter/indicator and model scores may have different b values.

The learning process yields for each of the n+2 scores the average of the score and its experimental standard deviation.

If standard tests do not show data with normal behavior, the process can proceed without the normal distribution assumption.

In the learning phase based on aggregated historic parameter values, the apparatus 1 may successively move an m-window from the beginning of an history file until the end. If each window is denoted by its ending record, as in run-time, the m-windows for j=m to N are being scanned. In each window, two model scores Sⱼ^{max} and Sⱼ^{total} and n parameter/indicator scores Sᵢⱼ (i=1, . . . , n) may be calculated.

The calculation produces a sequence of N−m+1 values of Sⱼ^{max}, Sⱼ^{total} and Sᵢⱼ for all scanned m-windows.

Each sequence may be in increasing order, and may refer to the sorted score arrays with the same notation, for example, Sⱼ^{max}.

In a preferred embodiment, the user defines a probability threshold—α, which actually expresses an acceptable type I error. The value α has a clear relationship with the previous threshold value b. α (and b) represent the acceptable proportion of false alarms.

An alert model may use the formula: Kₘₐₓ=the Sⱼ^{max} value at place [(1−α)*(N−m+1)] in the Sⱼ^{max} array, and set Kₘₐₓ as the threshold value for this model alert.

A histogram may be plotted based on the scores to find a threshold value, such that the area to the right is α.

Note that different user defined probability thresholds a may be used for model alerts and parameter/indicator alerts.

If in an m-window during run-time:

The number of alerts in one of the clusters>=Kₘₐₓ, then the model alert is activated.

The same procedure is repeated for Sⱼ^{total} and Sᵢⱼ (i=1, . . . n).

The learning process may yield for each of the n+2 scores a threshold value K derived from the score's individual experimental distribution.

Note that although the alerting process is based on m-window statistics, it is possible to calculate (parameter/indicator and window) scores for a k-window where k<m. This calculation may be applied when the process is starting and we do not yet have m consecutive records. In this case, we have to adjust the k-window calculated average as follows:

If s is the calculated k-window number of alerts then we may use an adjusting value factor—(m/k)*s. For example, (k/m)*sd may a normalized standard deviation. The system may send a message to the user that the alert is based on a k-window and hence the alert reliability is limited as it is based on a window which is smaller than the m rows window.

In the next step a (k+1)-window occurs, then a (k+2)-window occurs and so on. The message may be eliminated upon arrival at the m-window.

A learning stream of binary records on length n may be assumed.

Successive m-windows may be placed along the stream. For each m-window the n parameter/indicator values—Sᵢⱼ are calculated.
Let N₀ be the minimal number of records for learning and N the desirable number of records for learning. The learning may commence only when N₀ records are accumulated.

Preferably, the apparatus 1 identifies data diversions from a predetermined acceptable behavior that may potentially imply failures, to be ignored.

Preferably, the learning process is taken during specifically defined periods of the process.

It may be assumed that when there is an indication that the current unit is idle or is in a failing mode during data collection of the plant, this information may be used to eliminate the irrelevant/faulty data from the learning process.

In addition, there may be an automatic filtering of data entering the learning process. The model generator examines aggregated data records and if their relevant scores exceed their thresholds (b) an alert may be activated.

If, however, the score exceeds a predefined higher score b₁ (b₁>>b) then the record may be ignored during the learning process when the alert model is generated since it is assumed to be faulty and unrepresentative of normal behavior.

In a preferred embodiment, a user may be allowed to eliminate data from the learning process (e.g. if the user knows that the current unit is going to undergo a repair and that data generated for the unit during the repair may be ignored).

In a preferred embodiment, a standard deviation threshold b may be used to generate an alert model. However, the user may define different thresholds or rules to follow during the generation of the alert model.

Preferably, a learning file of data may be used to generate a PDF alert model which may associate a probability of occurrence with any point in an n-dimensional space defined by the input parameter values. A PDF may be created for single parameters or for several parameters.

The frequency over the space is calculated from input parameter values and may be presented as a table where the probabilities are given for discretized values of the parameters. The PDF is a continuous function of the parameter/indicator parameters.

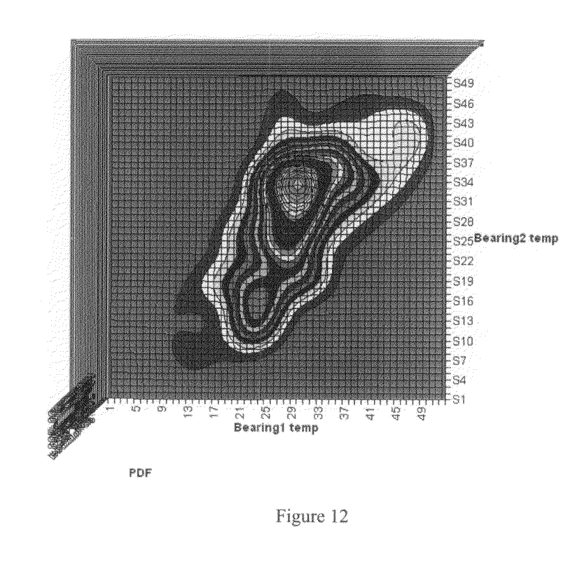

Reference is now made FIG. 12 which illustrates an exemplary two dimensional PDF alert model for a cluster of two interrelated parameters, according to a preferred embodiment of the present invention.

In the provided example, ‘Bearing1 temperature’ and ‘Bearing2 temperature’ are two interrelated parameters of the group of parameters describing the process that constitute a cluster. The cluster is input to the illustrated PDF alert model. The grid represents discretized temperatures, and the different shades represent different probabilities.

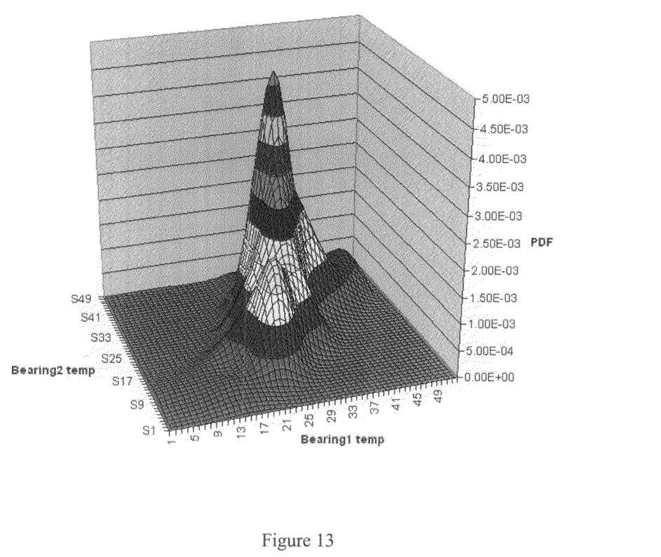

Reference is now made FIG. 13 which illustrates an exemplary three dimensional PDF alert model for a cluster of three interrelated parameters, according to a preferred embodiment of the present invention.

In this exemplary model, the higher points of the manifold indicate parameter value combinations having a relatively high probability of occurrence. Points at the lower part of the manifold are rare and thus represent rare situations that may indicated as such by the alert model.

Note that alert models utilizing m-windows, as described hereinabove, reduce false alarms. The higher the window length (m), the lower is the false alarm frequency. Model alerts (OOL and PDF) may be triggered if at least one of the scores Tjtotal and Tjmax or Tij for a parameter-i exceeds its threshold. Note that since any parameter/indicator can trigger a model alert there may be many false alarms in the model. Taking high threshold b for individual parameter/indicators may solve this problem.

As described herein above, an apparatus according to a preferred embodiment of the present invention may include a user interface manager that is associated with the rare situation detector 105. The user interface manager is used for managing a user interface. The user interface may be configured to allow a user to “drill through” data relating to a detected rare situation. Preferably, the user interface is a graphical user interface (GUI).

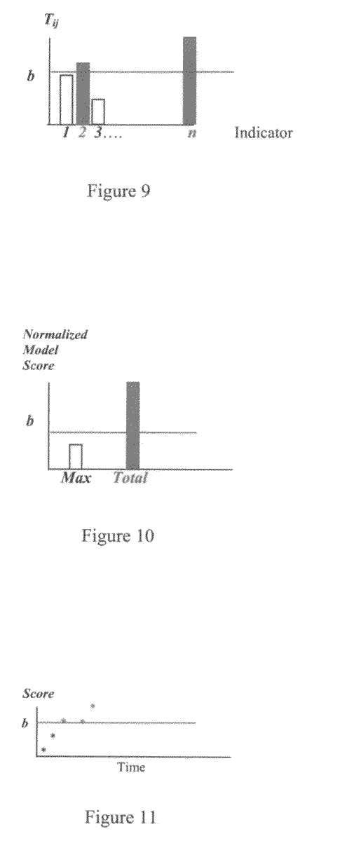

With a GUI, according to a preferred embodiment, if a model is alerted, an alert may be indicated, say by a colored icon or by any other alert means. The user may respond through the GUI, such as by double-clicking on that particular icon, thus drilling down to causes of the alert which are then displayed to the ser.
1. For example, if the alert is generated according to a HC alert model, then a pre-defined violated hazard condition may be displayed (e.g. HC #7−Temp>T1 and Pressure>P1, in this case Temp=X, Pressure=Y[X>T and Y>P1]).
2. In another example, if the alert is caused by an OOL alert model or by a PDF alert model, a histogram of parameter/indicator scores of the current window counts may be displayed, as illustrated in the exemplary GUI screen shown in FIG. 9. A parameter/indicator-i that exceeds the parameter/indicator threshold Tij>=b is shown to be dark (e.g. 2 and n).
3. Similarly model normalized scores may be also be displayed, as illustrated in the exemplary GUI screen shown in FIG. 10.
4. Optionally, by double-clicking on a particular parameter/indicator or on a model score, the GUI manager may graphically display the recent history (say, of the last hour) of the score as illustrated in FIG. 11.

The apparatus 1 according to the present invention is related to, but is not limited to systems that have a multitude of parameters that can be systematically measured during system operation.

In a preferred embodiment, the apparatus 1 aggregates historic data and constructs patterns of normal facility behavior. Then, a comparison may be made, say by the rare situation detector 105, between parameter values 100 and their normal behavior and alerts may be issued if the actual values deviate from the normal behavior patterns.

It is assumed that some of the input values of the parameters may represent the behavior of sub-units of the system.

Hence, when a combination of interrelated parameters, grouped in a certain cluster, deviates from a predetermined normal behavior, the sub-unit represented by the cell that the cluster is assigned to, as described in greater detail herein above, is believed to exhibit irregular behavior.

The detected rare event may be a precursor of a failure of the sub-unit. Consequently, it may be recommended that an appropriate alert be issued for the system operators to become aware of the situation, and if necessary to take preventive measures, so as to avoid potential failure or damage.

Thus, an apparatus according to a preferred embodiment of the present invention may implement a systematic method for distinguishing between normal and rare (abnormal) parameter combinations (multi-variant alerting) and may issue alerts whenever a rare situation is detected.

Preferably, a method implemented by the apparatus 1, may include, but is not limited to:
Inviting Experts/Facility Operators to examine available parameters and construct clusters of interrelated parameters.
Defining transformations of parameters included in the clusters (e.g. average or ratio of parameters, first principle formulas, data derived etc.).
Classifying each cluster into cells/units according to classifications, by experts. Some possible classifications can be:
   Physical sub units (e.g. boiler, coal grinder)
   Physical processes (e.g. cooling system, combustion process)
   Physical laws (e.g. mass or heat preservation)
Sharing parameters between clusters.
Each unit/cell may be associated with two or more parameters, or with one or more clusters.
Statistical limits may be calculated for each parameter (e.g. range of variation, minimum-maximum) during in a learning phase while ignoring failure data.
The system may create a discretization of each parameter (e.g. to sub-intervals) according to, but not limited to, a few possibilities:
   Uniform interval ranges.
   According to the data density in each sub-interval (similar number of values in each sub-interval).
The apparatus 1 may look at all possible pairs of parameters and examine each pair using a statistical method, as known in the art, for example using Shannon's Information Index which reflects the likelihood of the related data to exhibit a mutual pattern.
PDF (Probability Distribution Function) may be built for any pair that is determined to be highly informative. A PDF is a function, which expresses the probability of any data point in the relevant space
a PDF may be build for any number of variables.
According to a PDF alert model parameter values which have a low probability of occurrence can trigger an alert during run-time.
A PDF may be constructed using known in the art methods such as kernel functions. Above each point (in the learning data) a normal (Gaussian) distribution may be built. The height of the Gaussian is determined by the density of the points in the neighborhood. The Gaussian may not necessarily be symmetrical. A summation (and normalization) of all Gaussians yields a smooth manifold over the data space which defines the PDF.
A threshold value may be used to determine when the input parameter values may trigger an alert.
   A method according to a preferred embodiment of the present invention may include the following features:
Automatic learning from data history of the operation of the system to define rules for determining if a given combination of parameter values is normal/typical for the process, or is indicative of a rare situation occurring in the process which necessitates the issuing of an alert.
Incorporation of human knowledge and experience to enhance automatic data analysis. The human knowledge and experience may be extracted from experts inputting ranges or variation for parameters and/or introducing first principle formulas for an alert model, etc.
Creation of a learning data file, including records of parameter values for different times during a normal period.
Calculation of multi-dimensional probability distributions of parameter combinations in each cluster, which encapsulates the information needed to distinguish between normal and irregular/rare situations. The probability expresses the likelihood of the occurrence of a particular combination of parameter values.
Creation of a Probability Density Function (PDF) of clustered parameters for each cluster on the basis of the learning data file, while supporting incorporation of human knowledge and experience in the creation of the PDF.
calculation of the criteria presenting the information value in each cluster.
Selection of variables that represent a given cluster for participation in the creation of other clusters.
Discretization of the interval of definition of each parameter. Detection of first indications of a predetermined situation in advance such as potentially critical or dangerous.
Hazard trajectory—Calculation of hazard trajectory which is the direction and speed that a parameter combination is approaching a predefined data zone (hazard zone). Hazard zones may be determined by automatic data analysis and/or by inviting experienced experts and operators to define more accurately the problematic parameter value combinations.
Comprehensive facility alerting: a plurality of units, sub units or devices of a facility may each work properly individually but may jointly exhibit unusual behavior. Furthermore, a specific units, sub units or device may seem to work normally when considered as an isolated unit, but in certain environmental conditions such normal working may be considered abnormal. Preferably, the apparatus 1 according to the present invention provides a comprehensive facility level monitoring rather than a monitoring based solely on monitoring each unit individually.
The alert system may be based on a Knowledge Tree which describes the facility/process interrelationships and is used to issue a high-level (comprehensive) alert.
The knowledge tree may be used for classifying the parameters into a number of groups that are logically related.
For each group, pseudo Knowledge Trees are built, i.e. a definition of smaller groups of parameters.
Association of alerts with the related group of parameters. Thus providing initial clues for the root cause of the data irregularity.

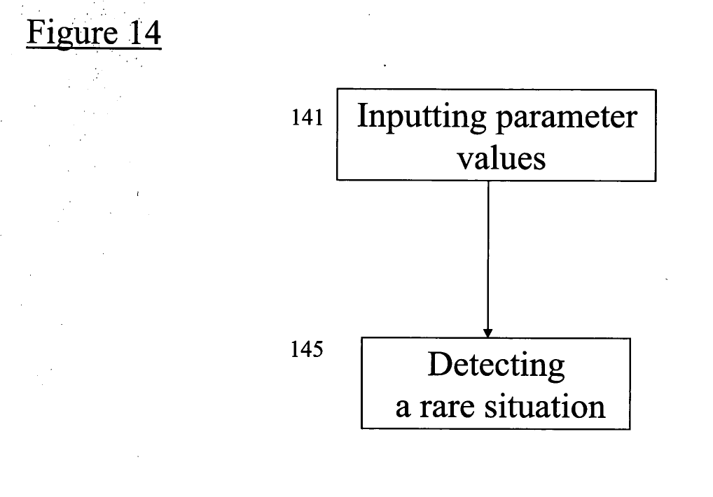

Reference now made to FIG. 14 which is a flow diagram, illustrating a method for detecting a rare situation in a process described by a plurality of parameters, according to a preferred embodiment of the present invention.

In a method according to a preferred embodiment of the present invention, the values of two or more interrelated parameters of the plurality of parameters describing the process may be input 141, say by a parameter value inputter 101, as described hereinabove for the apparatus 1. The interrelated parameters may constitute one or more cluster(s).

The parameter values may be collected utilizing an inputter 101, as described hereinabove. The inputter 101 may include or be associated in a direct or an indirect manner using means or sensors for collecting the values of the parameters that describe a monitored process, for detecting a rare situation in the process.

Then, a rare situation may be detected 145 according to an alert policy which is based on output values of one or more alert model(s). Each of the alert models is configured to provide an output value as a function of the input interrelated parameter values of the parameters describing the process.

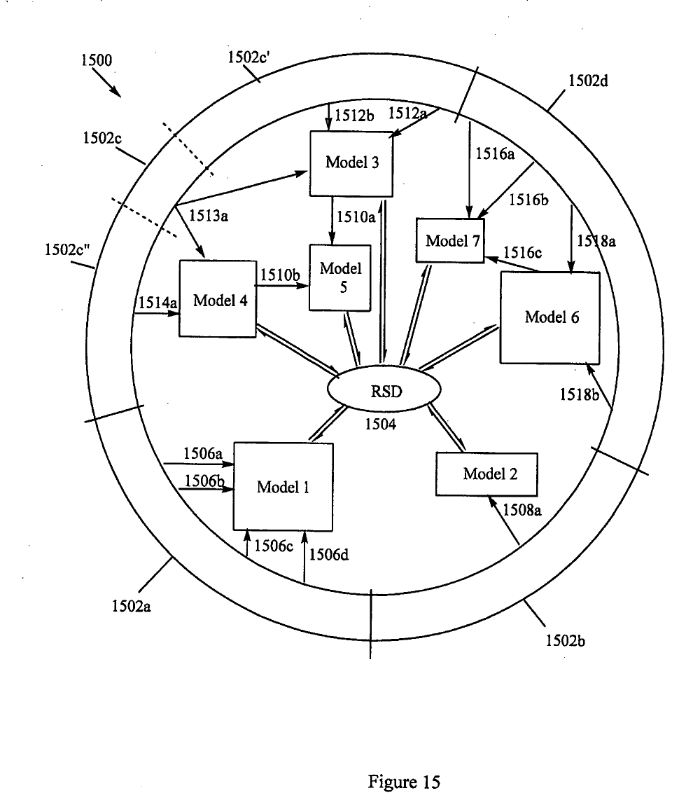

An alternative or additional aspect of the present invention is schematically depicted in FIG. 15. Device 1500 of the present invention is a control apparatus, for example for an industrial facility such as a power plant.

Device 1500 comprises an inputter 1502, a rare-situation detector (RSD) 1504 and a plurality of alert models: Model 1 through Model 7.

Inputter 1502 is substantially an interface supplying the values of parameters detected by the sensors and the like of a facility performing a process or processes to device 1500. The different parameters are divided into groups 1502a, 1502b, 1502c and 1502d. Preferably, each group includes parameters that are related to a specific unit of the facility. The parameters of group 1502c are further subdivided into subgroups 1502c′ and 1502c″ corresponding to subunits of the respective unit of the facility.

Group 1502a includes parameters 1506a, 1506b, 1506c and 1506d. Group 1502b includes parameter 1508a. Group 1502c includes parameters 1512a, 1512b, 1513a and 1514a. Subgroup 1502c′ includes parameters 1512a and 1512b. Subgroup 1502c″ includes parameter 1514a. Group 1502d includes parameters 1516a, 1516b, 1518a and 1518b.

Model 1 through Model 7 each receives as input the values of a cluster of parameters and, based on the received values, provides as output a status signal to rare situation detector 1504 indicating a state of the functioning of a unit or subunit with which the parameters of the cluster are associated. Methods of providing a status signal include methods such as described hereinabove or in U.S. patent application Ser. No. 10/157,713 of the inventor.

The rare-situation detector 1504 processes status signals received from any of Models 1 through 7 and is configured to initiate a required action according to an alert policy as described above. Required actions include but are not limited to actions such as activating a warning or an alarm, shutting down a subunit, unit or plant, scheduling or rescheduling maintenance, or interrogating further alert models (vide infra).

A given cluster generally, but not necessarily, includes parameters that are associated with a unit or a specific subunit of a unit as depicted in FIG. 15. A cluster includes one or more parameters the values of which are all used together by a given alert model to identify or calculate a state, generally of the respective unit or subunit. For example, parameter group 1502a relating to a unit of a plant includes a single cluster of four parameters 1506a, 1506b, 1506c and 1506d used together by Model 1 to calculate a state of a respective unit of the plant.

In an embodiment of the present invention, a cluster includes only one parameter. For example, parameter 1508a is the only member of the parameter cluster used by Model 2 to calculate the state of the respective unit of the plant.

In an embodiment of the present invention, a given parameter is a member of more than one cluster. For example, parameters 1512a and 1512b of subgroup 1502c′ are associated with a subunit of a unit of the plant and together with parameter 1513a constitute a cluster used by Model 3 to calculate the state of the respective subunit of the unit of the plant.

Parameter 1513a is also a member of the cluster including parameter 1514a of subgroup 1502c″ associated with a subunit of the unit of the plant, the cluster used by Model 4 to calculate the state of the respective subunit of the unit of the plant. In FIG. 15 it is seen that there is a hierarchy of alert models and consequently of clusters. It is seen that Models 3 and 4 provide parameter values 1510a and 1510b to Model 5 while Model 6 provides a parameter value 1516c to Model 7.

In embodiments of the present invention, parameter values provided by a first alert model to a second alert model, such as 1510a, 1510b or 1516c, are virtual parameters, that is values that are calculated from or result from the input cluster of the first alert model and in some embodiments are substantially similar or identical to a state provided by the first alert model to rare-situation detector 1504. In such an embodiment, a cluster used by Model 7 includes parameters 1516a, 1516b and a virtual parameter 1516c calculated by Model 6 from the values of parameters 1518a and 1518b.

In embodiments of the present invention, parameter values provided by a first alert model to a second alert model, such as 1510a, 1510b or 1516c are substantially some or all of the unprocessed values of parameters of the input cluster received by the first alert model. For example, in such an embodiment, parameter 1510b provided by Model 4 to Model 5 is simply a cluster including values of parameters 1513a and 1514a. It is seen that in some embodiments the hierarchy of alert models leads to the formation of clusters and subclusters of parameter. For example, Model 3 uses a subcluster including parameters 1512a, 1512b and 1513a as input, Model 4 uses a subcluster including parameters 1513a and 1514a as input and Model 5 uses a cluster composed of the two subclusters as input.

It is important to note, as is seen in FIG. 15, that not all parameters provided by inputter 1502 are used by a alert model and subsequently by rare situation detector 1504. As is discussed above, and in U.S. patent application Ser. No. 10/157,713 of the inventor, not all parameters are predictive and many parameters may be redundant. In embodiments of the present invention, parameters that are not members of a cluster are recorded and analyzed allowing generation of new alert models and allowing a rigorous post-rare situation analysis.

As described herein above, in embodiments of the present invention, clusters and subclusters of parameters reflects the physical structure of the facility, that is to say and as noted above a given cluster including primarily parameters related to a given unit or subunit of the plant. Such a hierarchy allows a reduction of the absolute number of parameters and status signals monitored at any one time and allows for simple and efficient location of a rare situation that occurs. For example in an embodiment of the present invention, parameter 1510a is a virtual parameter generated by Model 3 indicating the state of a subunit related to the parameters of subgroup 1502c′ and parameter 1510b is a virtual parameter generated by Model b indicating the state of a subunit related to the parameters of subgroup 1502c″.

Model 5 accepts as input virtual parameters 1510a and 1510b and usually outputs a “normal state” status signal to rare situation detector 1504. When either 1510a or 1510b indicate an abnormal state, Model 5 outputs an “abnormal state” status signal to rare situation detector 1504. As a result, rare situation detector 1504 substantially continuously monitors only a status signal received from Model 5. Upon receipt of an “abnormal state” signal from Model 5, rare situation detector 1504 interrogates Model 3 and/or Model 4 for a respective status signal to identify in which subunit the “abnormal state” has occurred, the subunit corresponding to parameters of subgroup 1502c′ or the subunit related to parameters of subgroup 1502c″.

In a preferred embodiment, device 1500 is implemented as a combination of software and hardware, where Models 1-7 and rare situation detector 1504 are subroutines or functions.

A method according to a preferred embodiment further includes clustering interrelated parameters of the plurality of parameters into one or more cluster(s).

Preferably, the interrelated parameters included in each cluster are determined either by a field expert or by algorithmic methods.

Preferably, each of the clustered parameters may be assigned into a hierarchical structure of cells, where each cell may represent a subunit or unit in the facility performing the process. The hierarchical structure may then be used to indicate a location of detected rare events as well as to alert a higher level cell based on a rare situation detected in one or many of subordinate cells of the higher level cell, as described in greater detail hereinabove.

According to a preferred embodiment, the alert may be presented to a user utilizing a user interface, preferably—a GUI, which may allow the user to drill from a higher cell alert, down to a subordinate cell where a rare situation causing the alert occurs, and to drill through detailed information relating to the rare event, recent parameter values of a cluster assigned to the subordinate cell, etc. as described in greater detail herein above.

It is expected that during the life of this patent many relevant devices and systems will be developed and the scope of the terms herein is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for detecting a rare situation in a process described by a plurality of parameters, the apparatus comprising:
a) a parameter value inputter, for inputting values of at least two interrelated parameters of the plurality of parameters, said interrelated parameters constituting at least one cluster; and
b) a rare situation detector for detecting a rare situation according to an alert policy, said alert policy being based at least on an output value of an alert model, said alert model configured to provide said output value as a function of said input parameter values of parameters constituting said at least one cluster.

2. The apparatus of claim 1, further comprising a clusterer, associated with said parameter value inputter, for clustering interrelated parameters of the plurality of parameters into at least one cluster.

3. The apparatus of claim 1, wherein each of said clusters is pre-assigned into a hierarchical structure of cells, wherein each cell represents an entity of a facility performing the process, wherein said rare situation detector is configured to provide information relating to a location of said rare situation in said facility based on said hierarchical structure.

4. The apparatus of claim 1, wherein said alert policy is based on at least one member of a group consisting of a probability distribution function, an out of line limit, and a hazard conditions definition.

5. The apparatus of claim 1, wherein said alert policy is based on information provided by a field expert.

6. The apparatus of claim 1, wherein said alert policy is based on detecting a deviation from a predetermined normal behavior.

7. The apparatus of claim 6, wherein said detecting a deviation from a predefined normal behavior includes referencing at least one of a group comprising average data and standard deviation data, said average data and standard deviation data pertaining to said normal behavior.

8. The apparatus of claim 1, wherein said alert policy is based on rate of approaching a predefined hazard situation.

9. The apparatus of claim 1, further comprising a discretizator, associated with said inputter, configured for discretizing said input parameter values.

10. The apparatus of claim 1, further comprising a model generator, associated with said inputter and said rare situation detector, for generating an alert model, usable for detecting said rare situation.

11. The apparatus of claim 10, wherein said model generator is further configured for extracting knowledge from a field expert, to be used for generating said alert model.

12. The apparatus of claim 10, wherein said model generator is further configured to aggregate and process input parameter values, to be used for generating said alert model.

13. The apparatus of claim 10, wherein said model generator is further configured for dynamically updating said alert model in accordance with new input parameter values.

14. The apparatus of claim 10, wherein said model generator is further configured to ignore failure parameter values when generating said alert model.

15. The apparatus of claim 10, wherein said model generator is further configured to utilize a dynamically updated moving window with respect to input parameter values, for generating said alert model.

16. The apparatus of claim 10, wherein said model generator is further configured to aggregate and process historic parameter values, to be used for generating said alert model.

17. The apparatus of claim 1, further comprising a user interface manager, associated with said rare situation detector, for managing a user interface, said user interface being configured to allow a user to drill through data relating to said rare situation.

18. Method for detecting a rare situation in a process described by a plurality of parameters, said method comprising:
a) inputting values of at least two interrelated parameters of the plurality of parameters, said interrelated parameters constituting at least one cluster; and
b) detecting a rare situation according to an alert policy, said alert policy being based at least on an output value of an alert model, said alert model configured to provide said output value as a function of said input parameter values of parameters constituting said at least one cluster.

19. The method of claim 18, further comprising clustering interrelated parameters of the plurality of parameters at least into one cluster.

20. The method of claim 18, further comprising assigning each of said clusters into a hierarchical structure of cells, wherein each cell represents an entity of a facility performing the process, wherein said detecting includes providing information relating to a location of said rare situation in said facility based on said hierarchical structure.

21. The method of claim 18, wherein said alert policy is based on at least one of a group consisting of a probability distribution function, an out of line limit, and a hazard conditions definition.

22. The method of claim 18, wherein said alert policy is based on information provided by a field expert.

23. The method of claim 18, wherein said alert policy is based on detecting a deviation from a predetermined normal behavior.

24. The method of claim 23, wherein said detecting a deviation from a predetermined normal behavior further includes referencing at least one of a group comprising average data and standard deviation data, said average data and standard deviation data pertaining to said normal behavior.

25. The method of claim 18, wherein said alert policy is based on speed of approaching a predefined hazard situation.

26. The method of claim 18, further comprising discretizing said parameter values.

27. The method of claim 18, further comprising generating an alert model, usable for detecting said rare situation.

28. The method of claim 27, further including extracting knowledge from a field expert, to be used for generating said alert model.

29. The method of claim 27, further including aggregating and processing input parameter values, to be used for generating said alert model.

30. The method of claim 27, further comprising dynamically updating said alert model in accordance with new input parameter values.

31. The method of claim 27, wherein failure parameter values are ignored when generating said alert model.

32. The method of claim 27, further comprising utilizing a dynamically updated moving window with respect to input parameter values for generating said alert model.

33. The method of claim 27, further comprising aggregating and processing historic input parameter values, to be used for generating said alert model.

34. The method of claim 21, further comprising allowing a user to drill through data relating to said rare situation.
